(19) United States
(12) Patent Application Publication
(10) Pub. No.: US 2014/0300494 A1
(43) Pub. Date: Oct. 9, 2014

(54) LOCATION BASED FEATURE USAGE PREDICTION FOR CONTEXTUAL HMI

(71) Applicant: FORD GLOBAL TECHNOLOGIES, LLC, Dearborn, MI (US)

(72) Inventors: Finn Tseng, Ann Arbor, MI (US); Johannes Geir Kristinsson, Ann Arbor, MI (US); Ryan Abraham McGee, Ann Arbor, MI (US); Dimitar Petrov Filev, Novi, MI (US); Jeff Allen Greenberg, Ann Arbor, MI (US)

(73) Assignee: FORD GLOBAL TECHNOLOGIES, LLC, Dearborn, MI (US)

(21) Appl. No.: 13/855,973

(22) Filed: Apr. 3, 2013

(51) Int. Cl. B60Q 9/00

(52) U.S. Cl. CPC B60Q 9/002
USPC 340/932.2

(57) ABSTRACT

A vehicle system having a controller configured to receive a sensor input. The controller may generate a feature score based at least in part on the sensor input and a location data within a database. The controller may associate the feature score to a selectable option. The controller may instruct a user interface device to display the selectable option in response to the feature score.

### BACKGROUND

A conventional vehicle includes many systems that allow a vehicle user to interact with the vehicle. In particular, conventional vehicles provide a variety of devices and techniques to control and monitor the vehicle's various subsystems and functions. As technology is advancing, more and more features are being introduced to control various subsystems within the vehicle. Some of these features may be presented to the user via a user interface. However, these features may be presented in a fixed manner to the user. Thus, there is a need for an enhanced and flexible system for presenting vehicle features to the user.

### SUMMARY

A vehicle system having a controller configured to receive a sensor input and generate a feature score based at least in part on the sensor input and a location data within a database. The controller may associate the feature score to a selectable option. The controller may instruct a user interface device to display the selectable option in response to the feature score.

A vehicle controller having a contextual module configured to receive a sensor input and a location data and generate an output based on the sensor input and location data. The controller may include a processor configured to receive the output from the contextual module and generate a feature score based on the output. The processor may associate the feature score with a selectable option. The feature score may represent a likelihood of the selectable option being activated. The processor may instruct a user interface device to display the selectable option based on the feature score.

A method including receiving a sensor input and generating, via a computing device, a feature score based at least in part on the sensor input and a location data within a database. The method may include associating the feature score with a selectable option and instructing a user interface device to display the selectable option based on the associated feature score.

### BRIEF DESCRIPTION OF THE DRAWINGS

FIG. 1A illustrates exemplary components of the user interface system;

FIG. 1B is a block diagram of exemplary components in the user interface system of FIG. 1A;

FIG. 2 illustrates a flowchart of an exemplary process that may be implemented by the user interface system;

FIG. 3 illustrates a block diagram of a possible implementation of the user interface system of FIG. 1A;

FIG. 4 illustrates a flowchart of a possible implementation that may be performed by the user interface system of FIG. 3; and

FIG. 5 illustrates a flowchart of an alternative implementation that may be performed by the user interface system of FIG. 3;

FIG. 6 illustrates an exemplary location database which may be utilized by the user interface system of FIG. 1A;

FIG. 7A illustrates a chart of exemplary score indicating the likelihood to stop output by the exemplary components of the user interface system of FIG. 1A;

FIG. 7B illustrates a chart of exemplary score indicating the likelihood to stop output by the exemplary components of the user interface system of FIG. 1A.

### DETAILED DESCRIPTION

A vehicle system may have a controller configured to receive a sensor input. The controller may generate a feature score based at least in part on the sensor input and a location data within a database. The controller may associate the feature score to a selectable option. The controller may instruct a user interface device to display the selectable option in response to the feature score, thus allowing the user to view options that may be of interest based on several attributes such as the sensor input and location data. In one example, the selectable options may include a park assist option and/or a valet option. The park assist option may automatically assist drivers in parking their vehicles. That is, the vehicle can steer itself into a parking space, whether parallel or perpendicular parking, with little to no input from the user. In another example, a valet option may be available. The valet mode may be activated near specific locations having valet services, such as hotels, restaurants, bars, etc. Thus, the exemplary system may detect when a vehicle is approaching an establishment where a user may wish to take advantage of either the park assist or valet options. These options may gain preference over other vehicle features, such as cruise control, and be presented to the user via the user interface device.

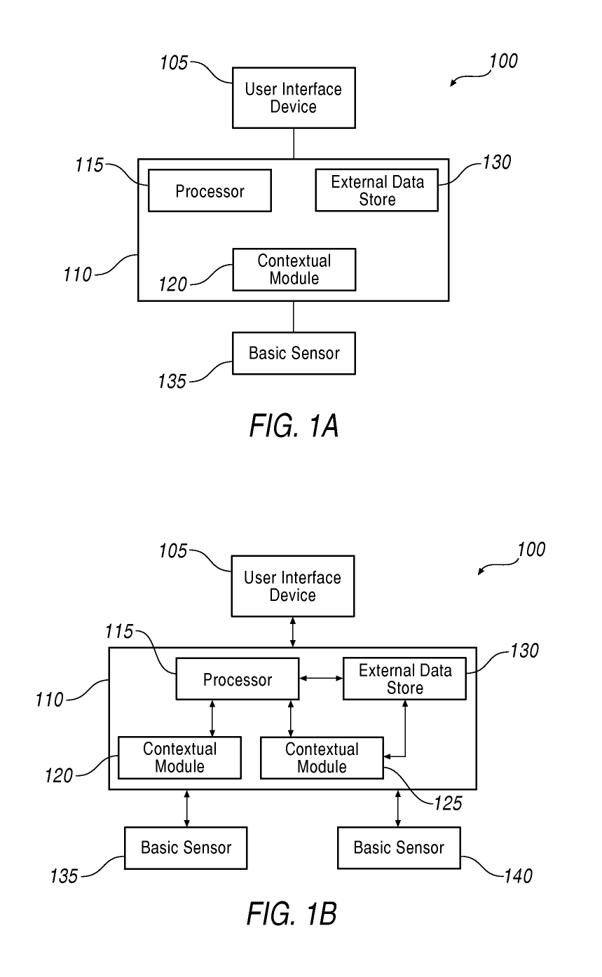

FIG. 1A illustrates an exemplary user interface system. The system may take many different forms and include multiple and/or alternate components and facilities. While an exemplary system is shown in the Figures, the exemplary components illustrated in the Figures are not intended to be limiting. Indeed, additional or alternative components and/or implementations may be used.

FIG. 1A illustrates a diagram of the user interface system 100. While the present embodiment may be used in an automobile, the user interface system 100 may also be used in any vehicle including, but not limited to, motorbikes, boats, planes, helicopters, off-road vehicles.

With reference to FIGS. 1A and 1B, the system 100 includes a user interface device 105. The user interface device 105 may include a single interface, for example, a single-touch screen, or multiple interfaces. The user interface system 100 may additionally include a single type interface or multiple interface types (e.g., audio and visual) configured for human-machine interaction. The user interface device 105 may be configured to receive user inputs from the vehicle occupants. The user interface device may include, for example, control buttons and/or control buttons displayed on a touchscreen display (e.g., hard buttons and/or soft buttons) which enable the user to enter commands and information for use by the user interface system 100. Inputs provided to the user interface device 105 may be passed to the controller 110 to control various aspects of the vehicle. For example, inputs provided to the user interface device 105 may be used by the controller 110 to monitor the climate in the vehicle, interact with a navigation system, control media playback, or the like. The user interface device may also include a microphone that enables the user to enter commands or other information vocally.

In communication with the user interface device 105 is a controller 110. The controller 110 may include any computing device configured to execute computer-readable instructions that controls the user interface device 105 as discussed herein. For example, the controller 110 may include a processor 115, a contextual module 120, and an external data store 130. The external data store 130 may be comprised of a flash memory, RAM, EPROM, EEPROM, hard disk drive, or any other memory type or combination thereof. Alternatively, the contextual module 120 and the external data store 130 may be incorporated into the processor. In yet another embodiment, there may be multiple control units in communication with one another, each containing a processor 115, contextual module 120, and external data store 130. The controller 110 may be integrated with, or separate from, the user interface device 105.

In general, computing systems and/or devices, such as the controller 110 and the user interface device 105 may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating system distributed by Apple, Inc. of Cupertino, Calif., the Blackberry OS distributed by Research in Motion of Waterloo, Canada, and the Android operating system developed by the Open Handset Alliance. It will be apparent to those skilled in the art from the disclosure that the precise hardware and software of the user interface device 105 and the controller 110 can be any combination sufficient to carry out the functions of the embodiments discussed herein.

The controller 110 may be configured to control the availability of a feature on the user interface device 105 through the processor 115. The processor 115 may be configured to detect a user input indicating the user's desire to activate a vehicle system or subsystem by detecting the selection of a selectable option on the user interface device 105. A selectable option is created for each feature available in the vehicle (e.g., temperature control, heated seats, parking assists, cruise control, etc.). Each selectable option may control a vehicle system or subsystem. For example, the selectable option for cruise control will control the vehicle system monitoring the vehicle's constant speed (or cruise control).

The controller 110, via the processor 115, may be configured to determine the features most likely to be of use to the driver or passenger, and eliminate the features that have minimal or no use to the driver/passenger, given the particular driving context. In order to determine the feature that may have the most relevance at the moment, the controller 110 may receive input from a plurality of contextual variables communicated by the contextual module 120 and the basic sensor 135 via an interface (not shown). The interfaces may include an input/output system configured to transmit and receive data from the respective components. The interface may be one-directional such that data may only be transmitted in one direction. Additionally, the interface may be bi-directional, both receiving and transmitting data between the components.

The controller may include many contextual modules 120, each configured to output a specific context or contextual variable. For example, one contextual module 120 may be configured to determine the distance to a known location. Another contextual module 120 may be configured to determine the vehicle's speed in relation to the current speed limit. Yet another contextual module may be configured to determine whether the vehicle has entered a new jurisdiction requiring different driving laws (e.g., a “hands-free” driving zone). In an exemplary illustration, each output may be received by each of the many selectable options, and may be used and reused by the selectable options to produce a feature score. That is, each of the many contextual modules 120 always performs the same operation. For example, the contextual module 120 for vehicle's speed in relation to current speed limit will always output that context, although the context may be received by different selectable options.

A contextual variable may represent a particular driving condition, for example, the vehicle's speed or a previous location in which the driver activated a feature. The contextual variables may be output from the contextual module 120 or the basic sensor 135. The controller 110 may be configured to select a feature with a high likelihood of vehicle user interaction based on the input received from the contextual module 120 and basic sensors 135. For example, the controller 110 may indicate that the feature for cruise control may be of particular relevance due to the driving context or circumstance. In one exemplary approach, each feature available on the user interface device 105 is represented by one particular selectable option. For example, the feature for a garage door opener may be always associated with a selectable option for the garage door opener.

The contextual variables may be a numerical value depending on the driving context. In one possible implementation, the contextual variables range from a value of 0 to 1, with 1 representing the strongest value. Additionally or alternatively, the contextual variables may represent a particular context, such as outside temperature, precipitation, or distance to a specific establishment. For example, the contextual variable output may indicate the vehicle is approaching an establishment that offers valet services. There may be two types of contextual variables: simple contextual variables and smart contextual variables. Simple contextual variables may be derived from the basic sensor 135. A basic sensor 135 may include any sensor or sensor systems available on the vehicle. For example, the basic sensor 135 could embody audio sensors, light sensors, accelerometers, velocity sensors, temperature sensors, navigation sensors (such as a Global Positioning System sensor), etc. Smart contextual variables may be output by the contextual module 120 and may represent other contextual variables aggregated into values which are not readily available in the vehicle. That is, no other system or subsystem within the vehicle can generate a smart contextual variable alone. For example, in order to produce the smart contextual variables, the contextual module 120 may receive inputs from either simple contextual variables output by the basic sensors 135 or other smart contextual variables output by contextual modules 120 and aggregate these outputs into complex values (e.g., aggregations of multiple values). There may be various ways in which the contextual module may produce their values. For example, techniques may involve Fuzzy Logic, Neural Networks, Statistics, Frequentist Inference, etc.

The controller 110 may include location data saved in a database, such as an external data store 130. The external data store 130 may be located within the controller 110 or as a separate component. The location data may include stop location data, for example, the previous stop locations of the vehicle, or selectable option data which may include, for example, the number of times a selectable option has been activated at a previous stop location (e.g., location-based feature usage). The location data may also include point of interest data, for example, valet points-of-interest which indicate locations that provide valet services (e.g., restaurants, hotels, conference halls, etc.). Point-of-interest data may additionally include the user's preference for a given situation, for example, a crowded establishment versus a secluded establishment. For example, the user may set his or her preference for restaurants that offer valet services which may influence the feature score attributed to each selectable option. While the data store 130 may be included in the controller 110, it may also be located remotely of the controller 110 and may be in communication with the controller 110 through a network, such as, for example, cloud computing over the Internet.

The processor 115 may be configured to communicate with the external data store 130 whenever saved information is needed to assist in generating a selectable option. The external data store 130 may communicate with the contextual module 125 to produce a smart contextual variable. Likewise, the external data store 130 may communicate directly with the processor 115. The external data store 130 may be composed of general information such as a navigation database which may, for example, retain street and jurisdiction specific laws, or user specific information such as the preferred inside temperature of the vehicle. Additionally or alternatively, the external data store 130 may track vehicle feature activations at specific locations or under particular driving conditions. For example, the external data store may save the number of cruise control activations on a specific highway. This may, in turn, effect the feature score for cruise control when the vehicle is driving on that highway. Further, the external data store 130 may be updated using, for example, telematics or by any other suitable technique. A telematics system located within the vehicle may be configured to receive updates from a server or other suitable source (e.g., vehicle dealership). Likewise, the external data store 130 may be updated manually with input from the vehicle user provided to the user interface device 105. Furthermore, the controller 110 may be configured to enable the user interface system 100 to communicate with a mobile device through a wireless network. Such a network may include a wireless telephone, Bluetooth®, personal data assistant, 3G and 4G broadband devices, etc.

In an exemplary illustration, the user interface device 105 may permit a user to specify certain preferences with respect to a location. A user may set a preference for locations providing valet services or offering a secluded dining environment. These preferences may be saved in the external data store 130 (e.g., as a point of interest) and may be utilized by the contextual module 120, 125 to affect the contextual variable output. For example, the feature score for valet mode at a particular establishment may be weighted higher (e.g., produce a higher feature score), if the user sets his/her preference to include valet mode, regardless of whether the user has previously stopped at that establishment. Thus, it may not be necessary to have previously stopped at a particular location in order to generate a high feature score if the user's preferences are customized in a certain manner.

The processor 115 may be configured to detect inputs, such as the contextual variables, communicated by the contextual module 120. The processor 115 may store each selectable option associated with a specific feature available for use by the user interface device 105. Each selectable option takes input from a range of contextual variables generated from a basic sensor 135 and the contextual module 120. The processor 115 aggregates the variables received to generate a feature score associated with the selectable options which indicates the likelihood the particular feature will be interacted with by the user. Thus, each selectable option is associated with a feature score. However, depending on the driving conditions and context, the feature scores associated with the selectable options may differ. Many implementations may be used to aggregate the contextual variables, such as, but not limited to, taking the product, summation, average, or non-linear algorithms such as fuzzy logic, for example. In one embodiment, the processor 115 may associate a decimal feature score of 0 to 1 with the selectable option, in which 0 may represent the feature is unlikely to be selected at the moment and 1 represents that the user has the highest likelihood of wanting to use the feature. Thus, a feature already in use (e.g., the vehicle system or subsystem is currently in use) would score low on the decimal system because there is no likelihood of future interaction with the feature. However, this choice may be altered by the driver or manufacture so that 1 represents that the user is actively interacting with the feature. Further, the decimal score range is illustrative only and a different range of numbers could be used if desired.

After the processor 115 generates a feature score, the processor 115 may promote the feature score to the user interface device 105. Based on the preference of the driver or manufacturer, the processor 115 may select the selectable option with the highest feature score to display on the user interface device 105. The highest feature score may be representative of the preferred selectable option or feature being selected. That is, the selectable option associated with the highest feature score may be the preferred feature. In an alternative embodiment, the processor 115 may rank the selectable options based on their feature scores and select multiple features with the highest feature scores to be displayed on the user interface device 105.

FIG. 1B illustrates a general system interaction of an embodiment of the user interface system 100. Initially, the controller receives input from basic sensors 135 and 140 which collect information from sensors or sensor systems available on the vehicle and output simple contextual variables. For example, the basic sensor could represent the current outside temperature, a vehicle speed sensor, or vehicle GPS location. The contextual modules 120 and 125 may receive simple contextual variables, other smart contextual variables, and/or location data from the external data store 130 to produce smart contextual variables. The processor 115 may receive both the smart contextual variables and simple contextual variables to ascribe their values to multiple selectable options. The selectable options are each associated with a feature score that is generated from the values of the contextual variable received. Every selectable option receives input from the basic sensors and contextual modules continuously. However, depending on the driving context, the feature scores associated with the selectable options differ. For example, if the contextual variables communicate that the vehicle is driving on a highway close to the speed limit, the selectable option for the feature cruise control will produce a high score, whereas the feature for heated seats or garage door opener will produce a low feature score.

The processor 115 may rank the selectable options according to their feature score. The processor 115 may select the highest scoring selectable option. Depending on how the user interface system 100 is configured, the processor 115 may either promote the selectable option with the highest feature score or promote multiple selectable options to the user interface device 105. At the same time, the processor 115 may eliminate a feature(s) from the user interface device 105 that no longer has a high likelihood of user interaction. The basic sensors 135, 140, and contextual modules 120, 125 are active at all times to facilitate the production of a continuous feature score for each selectable option. The processor 115 uses these scores to provide the most current driving contexts to the user interface device 105 so that the selectable option with the highest feature score is always displayed on the user interface device 105.

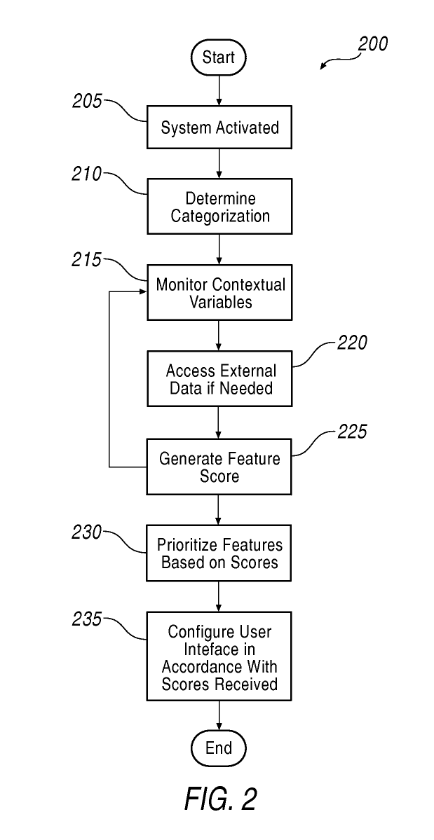

FIG. 2 illustrates a flowchart of an exemplary process 200 that may be implemented by the user interface system 100. The operation of the user interface system 100 may activate (block 205) automatically no later than when the vehicle's ignition is started. At this point, the vehicle may go through an internal system check in which the operational status of one or more vehicle systems and/or subsystems will be determined in order to ensure that the vehicle is ready for operation. While the internal system check is being verified, the system 100 may additionally determine the categorization of the selectable options available in the vehicle at block 210. The system 100 may additionally categorize the available features (and their corresponding selectable options) of the user interface system 100 into a departure group and an arrival group. The departure category may include features commonly used when leaving a location, for example, a garage door opener or climate control. The arrival category may include features commonly used when in route to or arriving at a destination, for example, cruise control or parking assistance. The categorization process may be performed by the controller 110. The separation of features may either be preset by the vehicle manufacturer or dealership, or the vehicle owner may customize the departure group and arrival group based on their preference. Separating the features into two or more groups may help reduce processing time in the later stages by limiting the number of features available for selection.

At block 215, the system 100 may begin monitoring the contextual variables produced by the basic sensors 135 and the contextual modules 120. As previously mentioned, the contextual variables may be either simple contextual variables which are derived directly from sensors available in the vehicle, or smart contextual variables derived from aggregations of other contextual variables (whether simple or smart) into values not readily available in the vehicle. The system 100 may further check whether additional external information is needed at block 220 from the external data store 130. This may occur where the contextual variables require stored information, such as street speed limits, location data, or cabin temperature preference of the vehicle user. If additional external information is need, the information may be communicated to the contextual modules 120 to generate a smart contextual variable. If additional external information is not needed, or has already been provided and no more information is required, the process 200 may continue at block 225.

At block 225, the contextual variables may be communicated to the processor 115 to generate a feature score. The processor 115 may aggregate the inputs (e.g., the contextual variables) received and associate the values to each selectable option to produce the feature score. The feature scores may be generated by aggregating the contextual variables by taking the product, average, maximum, minimum, etc., or any combination or variation, or any non-linear algorithm, such as fuzzy logic. The feature score may be directly proportional to the relevance of the aggregation of the contextual variables communicated to the processor 115. For example, when the contextual variables indicate that a vehicle is driving on a highway, has a relative speed close to the speed limit, but notices the vehicle is varying speeds above and below the speed limit (e.g., as in the case of heavy traffic), the feature score for the cruise control selectable option will have a lesser value compared to when the vehicle is traveling at a constant speed, near the speed limit, for a period of time. Furthermore, the same variables attributed to the parking assist selectable option, for example, will have a very low feature score because the likelihood of parking while traveling at high speeds is very low.

At block 230, the processor 115 may prioritize the selectable options based on their associated feature scores. Generally, the selectable options with the highest feature score may have the highest priority, and the rest of the available selectable options are ranked accordingly thereon. Depending on the user preference, either the feature with the highest feature score, or multiple features (e.g., the three features with the highest feature score), may be promoted to the user interface device 105 at step 235 for display and performance. Likewise, the features already displayed on the user interface device 105 may be simultaneously eliminated (or demoted) if their relevance within the particular driving context has decreased. Additionally or alternatively, the processor 115 or controller 110 may order the selectable options according to the feature score associated with each selectable option. The controller 110 may then determine the order of the selectable options with feature scores above a predetermined threshold. For example, the controller 110 may only select the selectable options with a feature score at or above 0.7. The controller 110 may then rank the available selectable options with the highest feature score to a first position in the order, and another selectable option with a slightly lower feature score to a second position in the order, and so on.

As shown, blocks 215 to 225 perform a continuous cycle while the vehicle is in operation. The basic sensors 135 and contextual modules 120 are active at all times, continually inputting information into the processor which continuously generates new feature scores. Accordingly, the processor 115 updates the priority rankings at block 230 so the most relevant features will be presented at all times on the user interface device 105 at block 235.

In at least one embodiment of the disclosure, the user interface system 100 may determine a selectable option based on received sensor inputs and location data. The location data may include previous stop locations and location-based feature usage. The selectable option may generally be activated based on the location of the vehicle relative to other known or previously defined locations. For example, the present disclosure illustrates the system and method for generating the selectable option for park assist and valet mode, both of which are activated when approaching specific locations (e.g., parking structure, office building, or restaurant). Park assist is an available vehicle feature that activates the vehicle system to automatically assist drivers in parking their vehicles. That is, the vehicle can steer itself into a parking space, whether parallel or perpendicular parking, with little to no input from the user. The valet mode or option is a similar feature that is activated near specific locations, such as hotels, restaurants, bars, etc., that include valet services. Activation of the vehicle system for the valet mode option may lock components of the vehicle (e.g., the user interface device, glove box, vehicle trunk) so that the valet driver cannot access private information that may be stored within the vehicle. The valet option may be triggered upon realization by the controller 110 that the vehicle is approaching an establishment with a valet service. This may be known by stored data relating to an establishment within the external data store 335.

The location-based options may be associated with a normalized usage frequency to indicate the number of times a selectable option has been activated at a particular location. The normalized usage frequency may be determined by the controller 110. The value of the normalized usage frequency (F_{AF}(i,j)) may be obtained using a two tier implementation. Initially, when the number of visits or observations is limited, a true value of the normalized frequency is generated using the first implementation. That is, before a predefined minimum number of visits to a location is met (Nₘᵢₙ), the total number of feature activations of a specific feature at a specific location is divided by the total number of visits to that location to give the true value of the number of times a feature has been activated at a location. The minimum threshold may be used in order to include a greater sample of observations of feature activations at a specific location to give a more accurate percentage. A minimum number of visits may include a value defined in the external data store 335 and may be set by the vehicle manufacture, dealer, or possibly the vehicle driver.

The true usage mode, or a percentage of how often a feature is used at a specific location, may give the actual number of times a feature has been used at a specific location. N(i,j)ₐ represents the number of feature activations at a specific location, e.g., the number of times a feature such as park assist has been used at a location such as the supermarket. For example, i is the location and j may be the feature. N(i)ₐₗₗ represents the total number of visits to location i. The true value may be calculated using the following formula: F_{AF}(i,j)=N(i,j)ₐ/N(i))ₐₗₗ.

If the total number of visits to a specific location has met or surpassed the predefined minimum, the process follows the second implementation. The second implementation involves a recursive formula which may be used to estimate the normalized usage frequency (F_{AF}(i,j)) online without the need for specific data points such as the number of feature activations at a specific location. The second implementation includes a learning rate which may reflect memory depth of the external data store 335, and a reinforcement signal that may progressively become stronger the more times a feature is activated at a location. The normalized usage frequency for the online mode may be calculated using the following formula: F_{AF}(i,j)=(1−α)*F_{AF}(i,j −1)+(α)*Sig_{reinforce}(i,j), where α=the learning rate (e.g., on a scale of 0 to 1, where 1 represents a significant learning rate), F_{AF}(i,j)=the normalized usage frequency of feature j at location i as explained above, and Sig_{reinforce}(i,j)=the reinforcement signal representing feature j being activated at location i (e.g., on a scale of 0 to 1, where 1 represents a strong reinforcement signal).

Switching to the recursive second formula helps address two issues. First, the formula reduces the amount of memory used because the second formula does not require N(i)ₐₗₗ or N(i,j)ₐ to estimate the normalized usage frequency. This may not only free up memory space, but also provide for faster processing time. Likewise, the online mode may generate a more reliable output because a minimum threshold of activations at a particular location has been met, indicating the driver's preference to use a particular feature often at a specific location. Further, the second formula reflects the most recent driving usage in case the driver's preference shifts. The value of the learning rate (α) can be modified to reflect the most recent interactions of the driver and a specific feature at different locations.

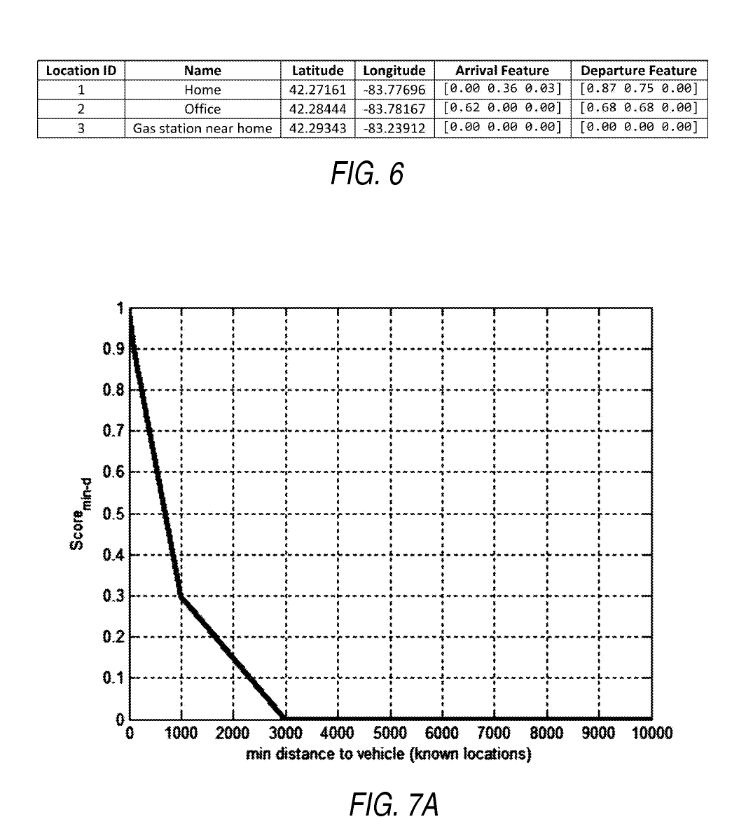

With reference to FIG. 6, the location-based options (e.g., park assist, valet mode, garage door control, etc.) may be activated when the vehicle approaches or leaves a specific location. In general, each specific location may have a record associated with the location within the external data store 335. The external data store 335 may include the latitude and longitude positions for a specific location (e.g., home, office, restaurant by office, etc.). Each record associated with a location may further include a field representing a normalized usage frequency relevant to specific features at the applicable location. Additionally or alternatively, each record may be saved in one or both of an arrival group and a departure group, thus creating two records associated with a location. By categorizing the locations, processing time may decrease.

Each element within the field represents the normalized usage frequency of a specific feature (e.g., cruise control, garage door control, house alarm activation, park assist, valet mode, cabin temperature, etc.). For example, in the arrival group record for Home, the field may contain the normalized usage frequency for cruise control, park assist, and cabin temperature, among others. If the feature (or selectable option) has never been activated at a specific location, the normalized usage frequency may be low, or possibly may not register in the field. For example, the selectable option for cruise control may register a normalized usage frequency of 0.00 at the Home location. On the other hand, the selectable option for garage door control within that field may register a higher normalized usage frequency depending on the number of selectable option activations or the learning rate for the selectable option. The normalized usage frequency for each feature may be constantly adjusted or updated to reflect the driver's or passengers' preferences.

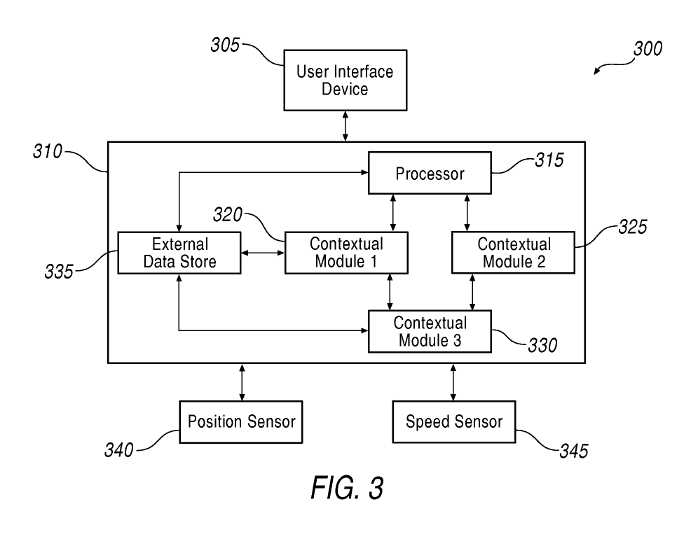

FIG. 3 illustrates an embodiment of the system 300 for the generating feature score for a selectable option. The system may include a user interface device 305, a controller 310 having a processor 315, contextual modules 320, 325, and 330, and a plurality of sensors 340, 345 communicating input to the controller 310. The variables produced by basic sensors 340, 345 and contextual modules 320, 325, and 330 are all communicated to the processor 315 to produce a feature score associated with a selectable option. The feature score may be used to determine the most relevant selectable option in relation to the driving context. The system 300 may further include location data stored in an external data store 335 which may contain, for example, previous vehicle stop locations, the number of park assist and valet mode feature activations per previous stop location, and user points-of-interest (POIs). The location data may be updated in the external data store after a certain period in time. For example, the external data store 335 may only save the previous vehicle stop locations from the past 30, 60, or 90 days. This may help reflect the driver's most current driving preferences, and may also decrease the amount of memory used by the location data.

In one embodiment, the system 300 may generate the selectable option for park assist. As explained, a position sensor 340 and a speed sensor 345 may be in communication with the controller via an interface. The vehicle speed sensor 345 may include a speedometer, a transmission/gear sensor, or a wheel or axle sensor that monitors the wheel or axle rotation. The vehicle position sensor 340 may include a global positioning system (GPS) capable of identifying the location of the vehicle, as well as a radio-frequency identification (RFID) that uses radio-frequency electromagnetic fields, or cellular phone or personal digital assistant (PDA) GPS that is transmitted via a cellphone or PDA by Bluetooth®, for example.

Each of the contextual modules 320, 325, 330 may perform a specific function within the controller 310. While each of their respective functions are described herein, these are merely exemplary and a single module may perform all or some of the functions. The third contextual module 330 may be configured to receive the vehicle's position from the vehicle position sensor 340 and the vehicle's previous stop locations from the external data store 335. Based on these sensor inputs, the third module 330 may determine a stop location (e.g., an establishment) located within a close proximity to the vehicle's current location.

The first contextual module 320 may be configured to obtain this stop location from the third contextual module 330. It may also determine how many times a specific feature has been used at this location. For example, the first module 320 may determine how many times park assist has been used at the establishment. This information may be available in a location record within the external data store 335 and may be used to determine the normalized usage frequency for the specific location (using either the true usage mode or the online usage mode formula), as described above. For example, the park assist usage per location may be input as N(i,j)ₐ and the number of visits to the closest previous stop locations may be input as N(i)ₐₗₗ for the true usage formula. On the other hand, all that may need to be input to the first contextual module 320 for the online usage mode may be the previous stop location, and a normalized usage frequency will be generated for the available selectable options. The first contextual module 320 may be configured to output the normalized usage frequency to the processor 315 to be used as input for generating a feature score for a selectable option, may be configured to output the normalized usage frequency to the external data store 335 in order to update the record of specific locations, or both.

The second contextual module 325 may be configured to obtain the vehicle's position communicated from vehicle position sensor 340 and the closest vehicle stop location communicated from the third contextual module 330 to determine the distance to the closest location. In an exemplary approach, the vehicle speed sensor 345 may be communicated directly to the processor 315. The outputs produced by the first and second contextual modules 320 and 325, and the vehicle's speed communicated by the vehicle speed sensor 345 may then be communicated to the processor 315 to attribute the values to the selectable option for park assist. The processor 315 may then generate a feature score associated with the park assist selectable option based on the variables received and display the park assist selectable option to the user interface device 305 for driver interaction.

Additionally or alternatively, the system 300 may produce a selectable option for a valet option/mode. Much of the system 300 is similar to the selectable option for park assist, except for the addition of valet Points-of-Interest (POIs). The valet POIs provide information regarding whether valet services are offered at a specific location or establishment. The valet POIs may be available either through an on-board map database saved as location data into the external data store 335 or in the form of a network service (e.g., cloud-based communication). The valet POIs may be obtained directly from the external data store 335 (e.g., the external data store 335 is programmed with specific locations that provide valet services) or by inference through interpretation of the name of the location in the external data store 335. For example, trigger words such as conference center, hotel, or restaurant may indicate that valet services are typically provided at such locations. If the valet POIs of a location are not already stored in the external data store 335, or the name of the location does not give rise to inference by interpretation, then activation of the valet mode selectable option at a particular location may be updated to the external data store 335 to associate that location with providing valet services. The valet POIs may influence the feature score for the valet mode selectable option because, if a location does not offer valet services, the particular feature may lose its relevance (and consequently generate a low feature score).

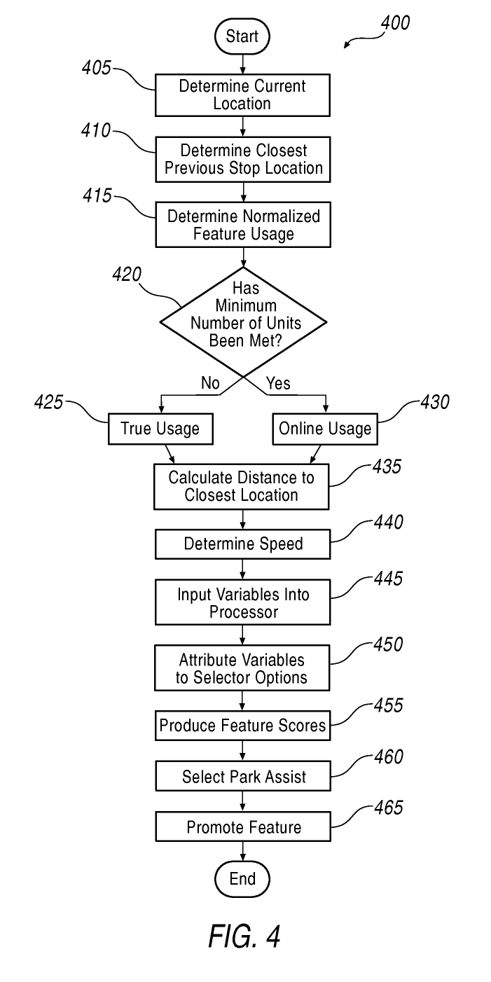

FIG. 4 represents a process 400 for generating a feature score associated with a selectable option. For exemplary purposes only, the forgoing explanation will refer to a park assist option. Initially, the current vehicle location may be determined at block 405. This may be accomplished by the vehicle position sensor 340. The information obtained by the vehicle position sensor 340 may be communicated directly to the third contextual module 330 at block 410. The third contextual module 330 compares the current position with the previous stop locations within the data store 335 to determine a closest previous stop location. For instance, the vehicle's current position output by the vehicle position sensor 340 and the previous stop locations communicated by the external data store 335 may be aggregated in the third contextual module 330 to produce the closest previous stop location (e.g., the vehicle's current position relative to previous stop locations stored within the external data store 335).

At block 415, the third contextual module 330 may communicate the closest previous stop location to the first contextual module 320. The first contextual module may then retrieve data associated with the closest previous stop location from the data store 335. This information may include the number of times a specific feature, e.g., the park assist, has been used at this location. This, in turn, may be used by the first contextual module 320 to calculate the normalized usage frequency, as described above. For example, the first contextual module 320 may also receive the number of selectable option (or feature) activations at the specific location from the external data store 335. The external data store 335 may indicate that the park assist selectable option has been activated seven times at the supermarket near the driver's home. If the total number of visits to the closest previous stop location has not reached the predefined minimum number of visits (e.g., N(i)ₐₗₗ≦Nₘᵢₙ), then the true usage mode (at block 425) will generate a contextual variable indicating the true usage frequency of using park assist at the specific location. On the other hand, after the minimum number of visits has been met (e.g., N(i)ₐₗₗ>Nₘᵢₙ), the online mode (block 430) will generate a smart contextual variable that estimates the normalized usage frequency of a feature at a particular location. Depending on the value provided by the Signal Reinforcement (Sig_{reinforce}(i,j)) and the learning rate (α), the contextual variable generated by the first contextual module 320 may either be strong (e.g., close to 1) or weak.

At block 435, the second contextual module 325 may receive input from the vehicle position sensor 340 and the closest stop location from the third contextual module 330 to calculate the distance between the current vehicle position and the previous stop location. The closer the vehicle is to the closest previous stop location, the greater the value of the smart contextual variable. Further, at block 440 the vehicle speed sensor 345 determines the vehicle's current speed. The simple contextual variable output by the vehicle speed sensor 345 is inversely proportional to the vehicle's speed. For example, if the vehicle is traveling at a rate of 40 mph, the likelihood that the vehicle is going to stop (and thus likelihood of using park assist) is low.

At block 445, the contextual variables output by first contextual module 320, the second contextual module 325, and the vehicle speed sensor 345 may be communicated to the processor 315. The processor 315 attributes values received to the selectable options at block 450. As previously mentioned, if the selectable options are categorized into an arrival group and a departure group, then the contextual variables may only need to be input into the arrival group selectable options. The variables may be aggregated to produce a feature score (block 455). The heuristics employed in aggregating the values may be achieved in various ways, including, but not limited to, taking the product, average, maximum or minimum of the values. At block 455, the processor 315 may take the product of the variables output by the first contextual module 320, the second contextual module 325, and the vehicle speed sensor 345 to generate the feature score for the selectable options.

At block 460, the processor 315 may select the park assist selectable option if the feature score is the highest relative to the other available selectable options. The processor 315 may promote the feature to be displayed on the user interface device 305 at block 465. At the same time, the processor may eliminate a feature already present on the user interface device 305 that may not be of relevance in the current context.

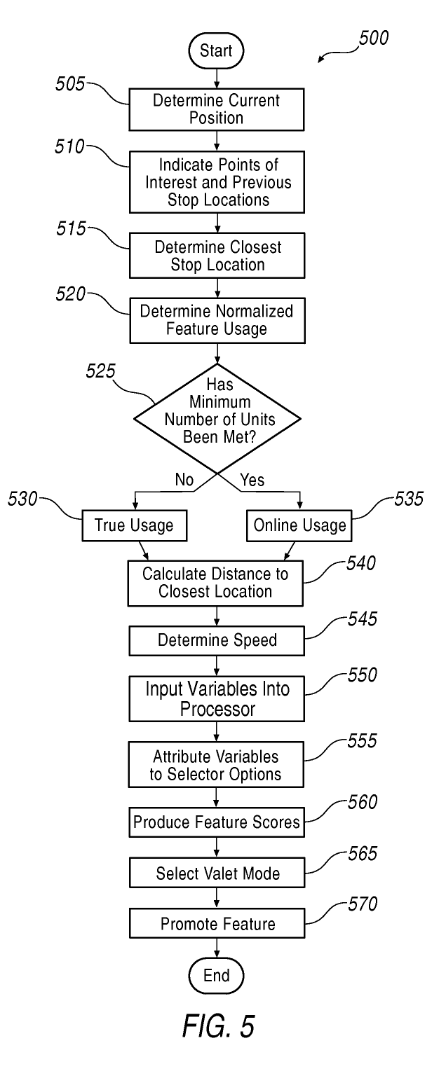

FIG. 5 illustrates a flow chart using an exemplary process 500 for generating the valet mode selectable option and promoting the selectable option to the user interface device 305. The current vehicle location may be determined at block 505 by way of a vehicle position sensor 340. At block 510, the external data store 335 may indicate the previous stop locations and valet POI to determine the relative location data based on the vehicle's current position. The external data store 335 may communicate the location data to the third contextual module 330. At block 515, the third contextual module 330 may combine the location data received by the external data store 335 with the vehicle's position output by the vehicle position sensor 340 to determine the closest previous stop location that offers valet services. As previously mentioned, the valet POIs may be obtained directly from the external data store 335, or the POIs may be inferred by reference to the name of the location (e.g., Restaurant, Movie Theater, Conference Hall).

At block 520, the closest previous stop location may then be communicated to the first contextual module 320 in order to determine the normalized usage frequency of valet mode at the particular location. For example, if the closest previous stop location is the restaurant by the driver's office, that will be input as (i) and the valet mode as (j) in the normalized usage frequency formula described above. If the minimum number of visits before switching to the online mode has not surpassed the total number of visits (e.g., N(i)ₐₗₗ≦Nₘᵢₙ), then the true usage frequency will be calculated at block 530. If, on the other hand, the amount of visits to location (i) has met the predefined minimum, the online usage frequency may be calculated using the recursive formula at block 535. Regardless of the formula used, a smart contextual variable for normalized feature usage for valet mode will be output from the first contextual module 320. If the normalized usage of valet mode selectable option is high, the likelihood of the feature being activated is high, and thus the smart contextual variable produced is high.

At block 545, the second contextual module 325 may receive the vehicle's position from the vehicle position sensor 340 and the closest previous stop location from the third contextual module 330 to determine the distance to the closest previous stop location. If the distance to the closest previous stop location that provides a valet service is small, the likelihood of the valet mode feature being selected is high (and again, the value of the smart contextual variable output is high). Additionally, the vehicle's speed is determined at block 545 by the vehicle speed sensor 345. If the vehicle's speed is low, the likelihood that the vehicle is going to stop in the near future is high.

At block 550, the vehicle's speed, the normalized usage frequency, and the distance to the closest location are input into the processor 315. The processor 315 may attribute the values to the available selectable options at block 555. The processor 315 may then produce a feature score for each selectable option by aggregating the values received at block 555. The processor 315 may additionally prioritize the selectable options that have surpassed a minimum threshold. The selectable option with the highest feature score may be assigned the highest priority, the selectable option with the second highest feature score may be assigned the second highest priority, and so on and so forth. If the feature score for the valet mode selectable option was attributed the highest feature score, and thus has been assigned the highest feature priority, the processor 315 may select valet mode at block 565 and promote it for display on the user interface device 305 at block 570. Alternatively, the processor 315 may select multiple selectable options having the first, second, etc. priority for promotion to the user interface device 305. The processor 315 may accordingly demote a selectable option that has a lower feature score relative to the driving context, such that the selectable option with the highest feature score is always displayed on the user interface device 315.

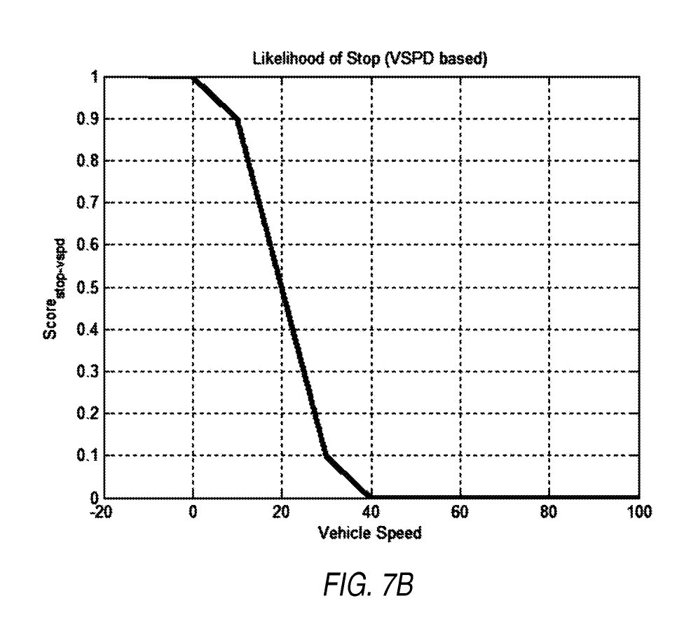

With reference to FIGS. 7A and 7B, the feature score associated with the various stop-location based selectable options (e.g., park assist or valet mode) may be based on at least three If/Then rules. If the normalized usage frequency of park assist or valet mode output by the first contextual module 320 is high, the likelihood (and thus the value of the contextual variable output) of the associated selectable option may also be high. FIG. 7A shows relative features scores based on the distance of a vehicle from a known location. As shown in FIG. 7A, if the distance to a known location (produced by the second contextual module 325) is small (e.g., less than 500 meters), then the likelihood that the vehicle is going to stop at the location is high. FIG. 7B shows relative feature scores based on the speed of a vehicle. As shown in FIG. 7B, if the vehicle speed (as determined by the vehicle speed sensor 345) is low, the likelihood of that the vehicle is going to stop at the location is high. The processor 315 aggregates these values to determine a feature score. Thus, a synergy between the three values may be required to generate a high feature score.

In one example, if the distance to the closest previous stop location is small and the normalized usage frequency is high, but the vehicle is traveling 45mph, it may be unlikely that the vehicle is going to stop at the location. Therefore, the feature score for park assist or valet mode, for example, may be low and thus, the user interface may not display such options. Similarly, if the vehicle is close to a previous stop location and the vehicle is traveling at a slow rate, but the specific feature has never been activated at the location, a relatively low normalized usage frequency may be realized and the likelihood of interacting with that feature (e.g., the feature score) will also be low.

Accordingly, the disclosure described herein provides a system to present the most relevant vehicle features that best matches the current driving context (e.g., vehicle speed, traffic condition, lighting condition, cabin temperature, weather condition, etc.) to the driver or passenger. By doing so, the driver may be able to use in-vehicle features more efficiently and effectively, allowing the driver to focus on the main task of driving.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

1. A vehicle system comprising:
a controller configured to:
receive a sensor input;
generate a feature score based at least in part on the sensor input and location data within a database;
associate the feature score to a selectable option; and
instruct a user interface device to display the selectable option in response to the feature score.

2. The vehicle system of claim 1, wherein the selectable option is a park assist option and a valet option.

3. The vehicle system of claim 1, wherein the feature score includes a highest score and wherein the selectable option associated with the feature score is a preferred feature.

4. The vehicle system of claim 1, wherein the location data includes a stop location and a selectable option data.

5. The vehicle system of claim 4, wherein the stop location is determined based on a previous stop location.

6. The vehicle system of claim 4, wherein the controller is configured to compare the previous stop location with the sensor input to generate a closest previous stop location.

7. The vehicle system of claim 6, wherein the controller is configured to determine a distance to the closest previous stop location based on the sensor input.

8. The vehicle system of claim 6, wherein the controller is configured to determine the number of times the selectable option has been implemented at the closest previous stop location.

9. The vehicle system of claim 4, wherein the controller is configured to:
determine, based on the location data, the number of visits to the previous stop location;
determine whether the number of visits exceeds a predefined threshold, and
calculate a normalized usage frequency of the selectable option at the previous stop location.

10. The vehicle system of claim 1, wherein the controller is configured to determine the selectable option based on the location data.

11. The vehicle system of claim 1, wherein the location data includes at least one valet location.

12. A vehicle controller comprising:
a contextual module configured to receive a sensor input and location data and generate an output based on the sensor input and location data; and
a processor configured to:
receive the output from the contextual module,
generate a feature score based on the output,
associate the feature score with a selectable option, wherein the feature score represents a likelihood of the selectable option being activated, and
instruct a user interface device to display the selectable option based on the feature score.

13. The vehicle controller of claim 12, wherein the location data includes a stop location and a selectable option data.

14. The vehicle controller of claim 13, wherein the contextual module is further configured to determine a normalized usage frequency of the selectable option, wherein the normalized usage frequency includes the frequency of past activations of the selectable option at the stop location.

15. The vehicle controller of claim 13, wherein the contextual module is configured to determine a closest stop location based on the sensor input and location data.

16. The vehicle controller of claim 15, wherein the contextual module is configured to determine a distance between the closest stop location and the sensor input.

17. A method comprising:
receiving a sensor input;
generating, via a computing device, a feature score based at least in part on the sensor input and a location data within a database;
associating the feature score with a selectable option; and
instructing a user interface device to display the selectable option based on the associated feature score.

18. The method of claim 17, wherein generating the feature score includes further determining a normalized feature usage, the normalized feature usage including an estimated frequency that the selectable option will be activated.

19. The method of claim 17, wherein the generating of the feature scores includes determining a previous stop location based on the sensor input and the location data.

20. The method of claim 19, wherein the generating of the feature score includes determining a distance between the previous stop location based on the sensor input.
